(19) United States
(12) Patent Application Publication
(10) Pub. No.: US 2015/0161751 A1
(43) Pub. Date: Jun. 11, 2015

(54) SEMI-AUTOMATIC GENERATION / CUSTOMIZATION OF (ALL) CONFIRMATIVE LEGAL ARGUMENT CHAINS (LACS) IN A CLAIMED INVENTION'S SPL TEST, AS ENABLED BY ITS "INVENTIVE CONCEPTS"

(71) Applicant: SIGRAM SCHINDLER BETEILIGUNGSGESELLSCHAFT MBH, Berlin (DE)

(72) Inventor: Sigram SCHINDLER, Berlin (DE)

(73) Assignee: SIGRAM SCHINDLER BETEILIGUNGSGESELLSCHAFT MBH, Berlin (DE)

(21) Appl. No.: 14/615,869

(22) Filed: Feb. 6, 2015

Related U.S. Application Data
(63) Continuation of application No. 14/165,225, filed on Jan. 27, 2014.
Application No. 14/165,225 is a continuation-in-part of application No. 13/923,630, filed on Jun. 21, 2013.
Application No. 13/923,630 is a continuation-in-part of application No. 13/777,416, filed on Feb. 26, 2013.
Application No. 13/777,416 is a continuation-in-part of application No. 13/608,543, filed on Sep. 10, 2012.
Application No. 13/608,543 is a continuation-in-part of application No. 12/756,254, filed on Apr. 8, 2010, now abandoned.
Application No. 12/756,254 is a continuation-in-part of application No. 13/229,362, filed on Sep. 9, 2011, now abandoned.
Application No. 13/229,362 is a continuation-in-part of application No. 13/093,682, filed on Apr. 25, 2011, now abandoned.
(60) Provisional application No. 61/925,367, filed on Jan. 9, 2014.
(60) Provisional application No. 61/923,000, filed on Jan. 2, 2014.
(60) Provisional application No. 61/913,677, filed on Dec. 9, 2013.
(60) Provisional application No. 61/862,712, filed on Aug. 6, 2013.
(60) Provisional application No. 61/820,932, filed on May 8, 2013.
(60) Provisional application No. 61/814,492, filed on Apr. 22, 2013.
(60) Provisional application No. 61/803,631, filed on Mar. 20, 2013.
(60) Provisional application No. 61/750,084, filed on Jan. 8, 2013.
(60) Provisional application No. 61/736,715, filed on Dec. 13, 2012.
(60) Provisional application No. 61/717,706, filed on Oct. 24, 2012.
(60) Provisional application No. 61/710,219, filed on Oct. 5, 2012.
(60) Provisional application No. 61/708,253, filed on Oct. 1, 2012.
(60) Provisional application No. 61/704,848, filed on Sep. 24, 2012.
(60) Provisional application No. 61/697,593, filed on Sep. 6, 2012.
(60) Provisional application No. 61/684,899, filed on Aug. 20, 2012.
(60) Provisional application No. 61/683,377, filed on Aug. 15, 2012.
(60) Provisional application No. 61/680,420, filed on Aug. 7, 2012.
(60) Provisional application No. 61/673,525, filed on Jul. 19, 2012.
(60) Provisional application No. 61/671,977, filed on Jul. 16, 2012.
(60) Provisional application No. 61/656,286, filed on Jun. 6, 2012.
(60) Provisional application No. 61/639,270, filed on Apr. 27, 2012.
(60) Provisional application No. 61/624,554, filed on Apr. 16, 2012.
(60) Provisional application No. 61/622,653, filed on Apr. 11, 2012.
(60) Provisional application No. 61/614,827, filed on Mar. 23, 2012.
(60) Provisional application No. 61/610,656, filed on Mar. 14, 2012.
(60) Provisional application No. 61/599,607, filed on Feb. 16, 2012.
(60) Provisional application No. 61/592,072, filed on Jan. 30, 2012.
(60) Provisional application No. 61/590,474, filed on Jan. 25, 2012.
(60) Provisional application No. 61/569,534, filed on Dec. 12, 2011.
(60) Provisional application No. 61/546,187, filed on Oct. 12, 2011.
(60) Provisional application No. 61/542,988, filed on Oct. 4, 2011.
(60) Provisional application No. 61/539,699, filed on Sep. 27, 2011.
(60) Provisional application No. 61/537,202, filed on Sep. 21, 2011.
(60) Provisional application No. 61/168,036, filed on Apr. 9, 2009.
(60) Provisional application No. 61/169,159, filed on Apr. 14, 2009.
(60) Provisional application No. 61/170,217, filed on Apr. 17, 2009.
(60) Provisional application No. 61/181,998, filed on May 28, 2009.
(60) Provisional application No. 61/183,279, filed on Jun. 2, 2009.
(60) Provisional application No. 61/184,938, filed on Jun. 8, 2009.
(60) Provisional application No. 61/219,209, filed on Jun. 22, 2009.
(60) Provisional application No. 61/223,127, filed on Jul. 6, 2009.
(60) Provisional application No. 61/227,565, filed on Jul. 22, 2009.
(60) Provisional application No. 61/234,376, filed on Aug. 17, 2009.
(60) Provisional application No. 61/236,366, filed on Aug. 24, 2009.
(60) Provisional application No. 61/240,401, filed on Sep. 8, 2009.
(60) Provisional application No. 61/252,894, filed on Oct. 19, 2009.
(60) Provisional application No. 61/255,372, filed on Oct. 27, 2009.
(60) Provisional application No. 61/259,930, filed on Nov. 10, 2009.
(60) Provisional application No. 61/261,585, filed on Nov. 16, 2009.
(60) Provisional application No. 61/263,679, filed on Nov. 23, 2009.
(60) Provisional application No. 61/296,089, filed on Jan. 19, 2010.
(60) Provisional application No. 61/304,549, filed on Feb. 15, 2010.
(60) Provisional application No. 61/313,860, filed on Mar. 15, 2010.
(60) Provisional application No. 61/319,088, filed on Mar. 30, 2010.
(60) Provisional application No. 61/533,499, filed on Sep. 12, 2011.
(60) Provisional application No. 61/531,358, filed on Sep. 6, 2011.
(60) Provisional application No. 61/528,431, filed on Aug. 29, 2011.
(60) Provisional application No. 61/526,831, filed on Aug. 24, 2011.
(60) Provisional application No. 61/522,865, filed on Aug. 12, 2011.
(60) Provisional application No. 61/515,493, filed on Aug. 5, 2011.
(60) Provisional application No. 61/504,435, filed on Jul. 5, 2011.
(60) Provisional application No. 61/497,140, filed on Jun. 15, 2011.
(60) Provisional application No. 61/477,870, filed on Apr. 21, 2011.
(60) Provisional application No. 61/476,162, filed on Apr. 15, 2011.
(60) Provisional application No. 61/472,915, filed on Apr. 7, 2011.
(60) Provisional application No. 61/447,401, filed on Feb. 28, 2011.
(60) Provisional application No. 61/442,896, filed on Feb. 15, 2011.
(60) Provisional application No. 61/440,053, filed on Feb. 7, 2011.
(60) Provisional application No. 61/435,551, filed on Jan. 24, 2011.
(60) Provisional application No. 61/431,129, filed on Jan. 10, 2011.
(60) Provisional application No. 61/428,941, filed on Dec. 31, 2010.
(60) Provisional application No. 61/427,244, filed on Dec. 27, 2010.
(60) Provisional application No. 61/426,825, filed on Dec. 23, 2010.
(60) Provisional application No. 61/420,058, filed on Dec. 6, 2010.
(60) Provisional application No. 61/418,179, filed on Nov. 30, 2010.
(60) Provisional application No. 61/417,477, filed on Nov. 29, 2010.
(60) Provisional application No. 61/417,330, filed on Nov. 26, 2010.
(60) Provisional application No. 61/416,478, filed on Nov. 23, 2010.
(60) Provisional application No. 61/415,964, filed on Nov. 22, 2010.
(60) Provisional application No. 61/415,021, filed on Nov. 18, 2010.
(60) Provisional application No. 61/414,483, filed on Nov. 17, 2010.
(60) Provisional application No. 61/413,517, filed on Nov. 15, 2010.
(60) Provisional application No. 61/412,822, filed on Nov. 12, 2010.
(60) Provisional application No. 61/410,971, filed on Nov. 8, 2010.
(60) Provisional application No. 61/410,066, filed on Nov. 4, 2010.
(60) Provisional application No. 61/408,790, filed on Nov. 1, 2010.
(60) Provisional application No. 61/408,291, filed on Oct. 29, 2010.
(60) Provisional application No. 61/407,076, filed on Oct. 27, 2010.
(60) Provisional application No. 61/394,822, filed on Oct. 20, 2010.
(60) Provisional application No. 61/389,829, filed on Oct. 5, 2010.
(60) Provisional application No. 61/387,217, filed on Sep. 28, 2010.
(60) Provisional application No. 61/384,770, filed on Sep. 21, 2010.
(60) Provisional application No. 61/380,377, filed on Sep. 7, 2010.
(60) Provisional application No. 61/374,312, filed on Aug. 17, 2010.
(60) Provisional application No. 61/352,528, filed on Jun. 8, 2010.

(51) Int. Cl. G06Q 50/18; G06Q 10/00

(52) U.S. Cl. CPC G06Q 50/184; G06Q 10/00

(57) ABSTRACT

A computer-implemented method of generating, customizing and providing “Legal Argument Chains, LAC.Z”, Z=1,2,3, . . . , by a “Innovation Expert System, IES”,
this IES comprising at least one of a processor, a memory for storing the method's executable code for the processor, an I/O device in particular for human interaction with an IES user, and
•) a “User Interface Entity, UIE”, composed of UIE.Y, Y=1,2,3, . . . ,
•) at least one UIE.Y per LAC.Z,
•) a “Memory of Method Execution, MEMEX”, comprising a set of storage cells, “KR-UIE.Y” and “HI-UIE.Y”, and a “Global Bibliography, GloBi”, accessible to the processor, and
•) IES being capable of running in a config-mode or a realtime-mode, and
the IES further comprising—since before starting the execution of this method or input to the IES during its execution via an I/O device of the IES—the “Test Set-UP, TSU” comprising the test determinants:
•) a given “First Order Logic Finite Legal Norm, FFLN” in some given notation,
•) a given “Pair of a <Technical Teaching^{FFLN}, Reference Set^{FFLN}>, PTR^{FFLN}”
—and leaving away the index “FFLN” here and for all terms in the rest of the claims, e.g. a “Pair of a <Technical Teaching, Reference Set>, PTR”—and
•) a given “PTR Data Structure, PTR-DS”
with “Some Innovation in FFLN, SI” is the “Technical Teaching in FFLN, TT.0” of the PTR and an FSTP-Test such that SI satisfies FFLN if and only if PTR passes this FSTP-Test and PTR-DS is the evidence that PTR satisfies FFLN by this FSTP-Test, and
•) a given “Arguable Subtest of this FSTP-Test of PTR, AST”,
with AST stored by some KR-UIE.Y,
for use by an IES user or the IES when executing the method, this execution comprising repeated invocations of the executions of the Action A) in a config-mode or B) in a realtime-mode of the IES:
A) the IES automatically prompts the user—to enable a UIE.Y to present in B) a LAC.Z in realtime mode—to invoke the IES to
   i. automatically identify a KR-UIE.Y storing an AST to be transformed into a LAC.Z, and
   ii. automatically identify an unused HI-UIE.Y, into which to input by a user—as part of Action A)—what the content and the representations shall be of LAC.Z, then supposed to represent the transformation of the AST on an I/O device of the IES, and to
   iii. automatically input “LAC.Z::=<KR-UIE.Y, HI-UIE.Y> into the GloBi.
B) i. the IES automatically prompts the user to identify a LAC.Z in the GloBi, and
   ii. the IES automatically presents the LAC.Z as defined in A) iii.

### I. INTRODUCTION

This SPL¹⁾ oriented patent application is a continuation in part of U.S. application Ser. No. 13/923,630 of “INVENTIVE CONCEPTS ENABLED SEMI-AUTOMATIC TESTS OF PATENTS”

The US Supreme Court's Mayo decision [C] [1] requires describing claimed inventions by their “inventive concepts, in-Cs”²⁾ if they are emerging technology and hence “model based”—thus stimulating “advanced IT” [2] research on decision making in testing such claimed inventions under SPL, also holding if no model is needed or “invention” is replaced by any “(new) knowledge” [18,19,25].

Models are e.g.: The “ISO/OSI” model of telecommunications³⁾, “molecular bonding forces” models of nano-technology, “RNA/DNA” models of genetics [D], “Natural Language” models of advanced IT—some standardized, all implicitly used by SPL precedents without being aware of this³⁾. The philosophical synonym of the term model is “paradigm”, the scientific one is “reference system”, e.g. “coordinate system”. Using a model/paradigm often enables describing inventions alias (new) knowledge precisely, though it itself is not understood or defined precisely—as practiced with mathematics' “axioms/theorems/proofs” and physics' “laws of nature”, here with SPL's “claimed inventions”.

[25] provides, for a claimed invention, 10 “FSTP tests”<=>It satisfies SPL iff it passes them all—mathematically proven [24,25]. Here is provided: These 10 FSTP tests may (semi-)automatically deliver all confirmative “Legal Argument Chains, LACs”. This greatly facilitates every patent practitioner's decision making as to testing a claimed invention under SPL, in particular if it is model based.

SPL may be generalized to any “First Order Logic Finite Legal Norm, FFLN”. A system based on a claimed invention's alias TT.0's PTR^{FFLN}-DS [11], storing all FFLN-relevant functional and nonfunctional properties of TT.0, is a “Innovation Expert System, IES”, if its “User Interface Entity, UIE” enables its user to access all in-C based (legally nonredundant) “LAC^{FFLN}S” as to TT.0. Another FFLN, besides SPL, is “Substantive Copyright Law, SCL”, with PTR^{SCL}-DS⊂PTR^{SPL}-DS [31,35].

A PTR^{FFLN}-DS for a claimed invention embodies of the 10 FSTP tests all “Arguable Subtests, ASTs”, being the blueprints of all LACs. The FFLN index will often be omitted in the sequel.

The UIE of a IES is made-up from UIE.Ys, Y=1,2,3, . . . , any UIE.Y having 3 “Layer-UIE.Ys, L-UIE.Ys”: Its knowledge representation “KR-UIE.Y”, its human interaction “HI-UIE.Y”, and its interaction control “IC-UIE.Y”, in config-/realtime-mode operating separately resp. synchronously. A IES or its user invokes between them an “Interaction” by a HI-UIE.Y, which uses via its IC-UIE.Y its KR-UIE.Y, which in turn uses the knowledge stored by PTR-DS [11,25]. Invoking a UIE.Y causes executing at least one of its “UIE.Y Steps”, which executes at least one of its “UIE.Y Moves”.

A LAC.Z, Z=1,2,3, . . . , is presented by executing a UIE.Y in realtime-mode. Thereby a LAC.Z may use a set of UIE.Ys, each presenting this LAC.Z in different logics and/or representations, as customized by a IES user in config-mode—between which a user may toggle by invoking HI-UIE.Y. I.e.: In config-mode of the IES, any AST is semi-automatically transformable into its LAC.Z in several UIE.Ys in various logics and/or multimedia presentations—as later needed by e.g. a judge, examiner, lawyer. In realtime-mode this user then may toggle between these UIE.Ys, highlighting aspects of this LAC.Z.

FIG. 1 shows a LAC.Z and its UIE.Ys comprising such sequential UIE.Y parts semi-automatically generated/customized, by generating/customizing for them their HI-UIE.Ys, KR-UIE.Ys, and IC-UIE.Ys.

### II. MAYO REFINES THE PHILLIPS/MARKMAN CLAIM INTERPRETATION

Any national patent law, e. g. the 35 USC, comprises procedural sections as well as substantive ones, in 35 USC being the 4 §§101/102/103/112, here called its SPL¹⁾. Testing a claimed invention under SPL means testing it under the 10 FSTP tests alias the FSTP-Test [7,25]. No other FFLN is considered in this Section, as it is evident that its elaborations hold for all FFLNs (see Section III.2).

The presented invention has been induced primarily by the US Highest Courts' SPL precedents [A-M], especially the Supreme Court's KSR/Bilski/Mayo decisions [A-C] implicitly prompting the CAFC to refine Markman/Phillips [L,M] for enabling consistent and predictable patent precedents for model based emerging technology inventions—i.e. to take SPL precedents to a higher level of development.

By its Mayo decision the Supreme Court outlined this higher level of development of SPL precedents: By requiring that it identifies—especially of a model based claimed invention its “inventive concepts”²⁾ and ensures its claim('s scope) is not “preemptive”. I.e., Mayo:
α) confirms—by explicitly requiring to identify the “inventive concepts” defining the claimed invention's (potentially) patentable part—what already Phillips has required by: “The inquiry into how a person of ordinary skill . . . understands a claim term provides an objective baseline from which to begin claim interpretation”. This “Phillips opening statement”—to first “provide an objective baseline”—is often totally ignored, though without this “baseline” logically this inquiry is rationally impossible to answer (see i)).
β) additionally requires to ensure by all of these inventive concepts that the claimed invention resp. its claim is •) nonpreemptive (i.e. not an abstract idea only), •) not non-patent-eligible (i.e. comprises at least one patent-eligible inventive concept), and •) patentable (i.e. considering only all its patent-eligible inventive concepts indicates its patentability). All three checks are easily possible, once the claimed invention's inventive concepts are identified—not elaborated on here (but e.g. in [25]).

These two Mayo requirements imply: The so refined/post-Mayo claim construction is, compared to the classical one and also for a model based claimed invention, of legally substantially increased
conciseness, by first focusing on its inventive concepts disclosing its by §101 required novelty and usefulness—i.e. ignoring its claim's terms²⁾ disclosing legally misleading technical aspects—and
coherence, by ensuring its §112, its §101, and its §§102/103 aspects are all “well-defined” [5, 25].

These clarifications added by the Mayo decision to claim interpretation⁴⁾ unfortunately did not yet make it into the often quoted—increasingly questioned [21]—USPTO's “Broadest Reasonable Interpretation, BRI” guideline [14], originating pre Phillips. It thus still preserves its uncertainties causing insinuation, some volitionally broadening the meanings of claim terms of a claim were lawful, as USPTO practiced³⁾—although Markman/Phillips and now also Mayo diametrically contradict it⁴⁾. Because of this uncertainty, providing semi-automatic decision support by LACs that a claimed invention does satisfy SPL is impossible. Consistency and predictability of SPL precedents is impossible to achieve, if the BRI guideline remains as it is and should make it into SPL precedents. But this is very unlikely and its change is overdue, as it multiply contradicts the Highest Courts SPL precedents and there is no US law supporting this BRI guideline—which might render these then unavoidable contradictions lawful.

The paragraphs i)-iv) elaborate on some of these—already pre-Mayo existing—contradictions between the current BRI guideline's uncertainties and the Highest Courts' Markman/Phillips decisions.
i) The BRI guideline starts its legal opinion by quoting, in its “BRI opening statement”—as to the general requirement of determining a claim term's meaning by the claimed invention's specification—a statement from the Phillips decision in a misleading way^{2),4)}. It “requires that . . . .) claims must conform to the invention as set forth in . . . the specification and the :) terms . . . in the claims . . . so that the meanings of the terms in the claims . . . ”. The second part of this quotation is misleading as it talks of the meaning of the “terms in the claims”, i.e. of the resp. plain “claim's terms” meanings^{2),4)}, not about “claim terms' meaning”.

This is a misrepresentation of the Phillips decision, which makes this “BRI opening statement”
•) only after it has made many statements explicitly forbidding such “mislead” kinds of term interpretations⁴⁾. By the Phillips opening statement only “claim terms' meanings” are material, which tie claim terms' interpretations tightly to the claimed invention⁴⁾—as confirmed by Mayo—and
•) when it was in a different context than the here given one, in which it is not an issue, whether a term interpretation is mislead. Phillips made this statement as to “It is . . . appropriate . . . , when conducting claim construction, to rely heavily on the written description for guidance as to the meaning of the claims.”. The Phillips decision's own comment on this BRI opening statement of the BRI guideline even clarifies: •) The USPTO itself has introduced it into this discourse, not the CAFC, and •) the BRI opening statement must in no way relax this requirement⁴⁾ to tie claim terms' meanings tightly to defining the claimed invention's “§101 usefulness”.
ii) Another—quite similar—up-front deficiency of the BRI guideline is that the USPTO ignored the fundamental Phillips opening statement (quoted in α)) and choose for its BRI guideline the just explained BRI opening statement, which insinuates a claim's terms need not be subject to the much tighter limitations imposed on them by the Phillips opening statement⁴⁾. This may be even disabling the limitations of the claimed invention, as parts of the description without any relation to the claimed invention may also support claim terms and mislead the claim interpretation definitively away from the claimed invention—in spite of its being clearly described by the specification³⁾.

Summarizing i) and ii): Right from its beginning the BRI guideline presents Markman/Phillips in an untenable as totally misleading fashion.
iii) Immediately after its “BRI opening statement”, the BRI guideline starts encouraging—perhaps feeling uneasy about the CAFC's Phillips ruling, which refines the Markman rulings but does not break them down into legally non-existing simplistic whatsoever tests [25], as desired by many—all the old confusions about claim interpretation by referring to a series of 5 pre-Phillips decisions (going back to 1969) and confronting the reader again with the at that time occasionally ominous claim interpretation, which to prevent for the future has been the main purpose of the Markman/Phillips and now also Mayo decision! It thereby indeed becomes “obscure” [21] by quoting from them a most mysterious sentence, as forbidding: “. . . thereby [to] narrow the scope of the claim by implicitly adding disclosed limitations which have no express basis in the claim”. Though its underlined part is indefinable it insinuates a known thinking not authorized by but contradicting Phillips and thus flushes the clarification provided by the Phillips thinking—as it thus invites the indefiniteness of pre-Markman/Phillips/Mayo claim interpretations.
iv) Removing uncertainties caused by the BRI guideline requires also addressing another broad and surprising statement. It quotes the CAFC: “The court held that the PTO is not required, in the course of prosecution, to interpret claims in applications in the same manner as a court would interpret claims in an infringement suit.”. While this quotation insinuates it were quite generally applicable, it seemingly was not intended by the CAFC to be so understood. The BRI guideline namely continues quoting the CAFC: “PTO applies to verbiage of the proposed claims the broadest reasonable meaning . . . ”. The CAFC then rather intended it to be used by the USPTO only for clarifying “below rationality” claims⁴⁾. Thus, claim interpretation remains an issue of law.

To terminate this Section: Its elaborations on claim interpretation did not serve for diving once more into the currently occurring paradigm refinement in the US SPL precedents [25]— in particular into its clarification of the terms/notions/meanings “inventive concept”, “creative concept”⁵⁾, “inventivity” and “usefulness” embodied by a claimed invention^{6),7)}, its “not being an abstract idea only”/“(non)pre-emptiveness”, its “classical/pre-Mayo” vs. “refined/post-Mayo” claim construction, . . . , all required or implied by the Supreme Court's Mayo decision, in beautiful clarity also by earlier German BGH precedents [6]—but for showing that SPL claim construction requires, because of its pitfalls especially with³⁾ model based claimed inventions, much more “problem awareness” than the current BRI guideline owns.

### III. GENERATING (ALL) LACS FOR A CLAIMED INVENTION'S TEST UNDER SPL

This patent application's specification does not elaborate on the simplest IESes here seeking patent protection—as their technical implementation is evident for the posc—but on the more sophisticated ones and discloses, how any AST of a claimed invention tested under SPL is transformed into its peer UIE.Y/LAC.Z. This is possible as the IES is PTR-DS based. This enables the IES, in its calibration in config-mode, automatically identifying all its AST.Zs and deriving from them all peer LAC.Zs, via at least one peer automatically generated UIE.Y per AST.Z. Per any so automatically generated LAC.Z the user may generate further UIE.Ys, all as outlined by the end of Section I. The below SPL elaborations hold for any FFLN, too, as explained by the end of this Section III.

Performing, for a PTR-DS, this KR transformation of the set of all ASTs into the set of all LACs—and customizing these—is evidently quite different from and much simpler than the “general argument recognition” problem [30]: Here the arguments necessary and sufficient for deciding whether an invention satisfies SPL are provided by their AST blueprints, i.e. its FSTP-Test, while nothing alike has been isolated first, there. Whether the knowledge addressed in [30] may be presented as a PTR^{FFLN}-DS is not an issue, here. If some additional limitations are acceptable, this should be possible, partially at least.

[25] has shown that a claimed invention satisfies SPL iff it passes the FSTP-Test alias the conjunction of all its 10 FSTP tests, FIG. 2. Thereby its passing of an FSTP test.m, 2≦m≦10, on top of a subset S″ of TT.0's finite set of all its BED-in-Cs (=“Binary Elementary Disclosed inventive Concepts” [25]) implies that it passes all FSTP test.n, 1≦n<m, on top of S″. The inverse of this implication needs not to hold. Yet, all whatsoever such inverses evidently exist on top of exactly those finitely many sets S″, which are semi-automatically determinable by using the FSTP-Test in explorative mode on all finitely many sets of BED-cr/in-Cs—i.e. not only the inverses as to the 10 FSTP tests, but also the inverses as to all ASTs, being all the lexically and syntactically correct terms of the “program” of the FSTP-Test [25]. For all ASTs hence also their semantics are evident, except those of the user input into the PTR-DS. PTR dependent, only finitely many (few hundred) ASTs exists. All these ASTs are executable on top of these finitely many and PTR-dependent BED-in-C subsets S″. All these ASTs are the blueprints for all LACs. Other (legally nonredundant) LACs don't exist—though many different presentations of any LAC.

The generation/customization of LAC.Zs is outlined already by this Section's first paragraph; the next bullet points add some more details, sometimes redundantly to what has been explained already.
• Any UIE.Y for a LAC.Z may be composed in config-mode by an IES user by its invoking the “HI-UIE.Z stub” provided by any IES implementation, also for checking the result of preceding input, or the interworking between presenting several UIE.Y invocations of LAC.Z, or its interworking with other LAC.Z presentations. Thereby any UIE may be composed by the user of one or several sequential “UIE steps, UIESes”, whereby any UIES may be composed by the user of one or several sequential “UIE moves, UIEMs”. Any UIE.Y, UIES.Y, and UIEM.Y must be specified by the user—except for the automatic ones, depending on the particular IES implementation and/or configuration—as to the functionalities of their 3 resp. HI-/IC-/KR-UIE.Ys, HI-/IC-/KR-UIES.Ys, and HI-/IC-/KR-UIEM.Ys.
• Providing the specifications by a user for one of the just mentioned parts of L-UIEs is (basically) the same on any one of the 3 Layers and for any L-UIE/UIES/UIEM, i.e. may be done stereotypically.
• Thereby the objective need not be limited to providing only LAC.Zs for justifying the classical claim construction for a claimed invention—being only LAC.Zs necessary for showing that it has a chance to satisfy SPL—but all LAC.Zs sufficient to show its satisfying SPL whatever is being questioned.
• After semi-automatically transforming the PTR-DS and its user input into all LAC.Zs in a multitude of logics details and user interaction representations, these LAC.Zs may be invoked automatically in realtime-mode e.g. by a word spotter of the IES, and/or (semi-)automatically by an IES user, whereby this invocation may even comprise specific UIE.Ys, too. Pertinent ordinary skill knows, e.g. from IVR systems and their audio pattern spotting and matching functionalities, how in principle to (semi-) automatically identify in realtime LAC.Zs to be instantly invoked, as the dialog just taking place generates an appropriate pattern. Here such LAC.Z identification and invocation processes may be substantially supported by the IES calibration providing hints by issuing, in realtime-mode, graphical and/or acoustic patterns compiled on the basis of a commonly known automatic thesaurus generation, which leverages on “AST patterns”.

FIG. 1 shows, how structurally a PTR-DS, therein an AST.Z, the peer LAC.Z, and for the latter several UIE.Zs—for simplicity here the former UIE.Y are also denoted as UIE.Zs (see below)—fit together, i.e. the main inventive concepts embodied by the claimed invention. As explained above and in the remainder of the specification, any implementation of the claimed invention is made up from the UIE.Zs, i.e. their L-UIE.Zs, L=HI, IC, or KR. They glue any AST.Z specific part of PTR-DS to exactly one LAC.Z. LAC.Zs need not to, but may, exist in an implementation of the claimed invention. I.e., the purpose of LAC.Zs is to convey the information stored in AST.Z to the user—to meet its explicit or implicit demand—in a multimedia presentation on the I/O devices of the IES, which is comprehensible and convenient for it and anytime controllable by it. Hence, LAC.Z presentations may exist in the very second they are generated by the IES, may be flighty/non-permanent—though they also may be stored by the IES as kind of multimedia clips and then optionally be output from there. Thereby the value set of the index “Z” of an AST in general is different from that of a UIE, and this is different in general from that of its LAC. E.g.: This value set for ASTs may reflect any AST's location in the PTR-DS. For any AST its AST.Z-value would be mapped onto that index subset of all the LAC.Z-values, which identify a specific LAC peer to this AST—evidently there would be several such LACs, in general. And any such pair <AST.Z-value, LAC.Z-value> may be indexed by the index subset of all UIE.Z-values, which glue this AST to this specific LAC. Thus, for any AST.Z-value there is a set of pairs <AST.Z-value, LAC.Z-value>, and for any such pair a set of triples <AST.Z-value, LAC.Z-value, UIE.Z-value>. These index sets, their structures into subsets, and their associations may be conveyed by the HI-UIEs of an implementation of the claimed invention to a user (and then in an implementation's specific presentation) in total, or in part, or not at all. As to these index associations, it is of no concern that any LAC.Z may be structured into its individual steps and moves—these may be induced by the structure of its peer AST.Z or by a user's needs or by both. In any case this structure of a LAC.Z is reflected by any one of its peer UIE.Z, i.e. by its L-UIE.Z, L=HI, IC, or KR. More precisely: This structure is controlled by this IC-UIE and provides the “raster” to which a user's control activities as to a LAC.Z may refer, the “synchronization points” therein available to the user when working with this LAC.Z.

The preceding elaborations hold also for any PTR^{FFLN}-DS based IES, i.e. for any PTR in which all relations between finitely many legal norms alias requirements to be met by PTR's TT.0 (e.g. the SPL or SCL), between the BED inventive concepts making up the TT.0, and between elements of both these types are describable by First Order Logic. Any such PTR^{FFLN}-DS would namely be based on a finite set of FSTP^{FFLN} tests (similar to the 10 FSTP tests of FIG. 2 and straightforward to develop analogously)—just as the peer AST^{FFLN}S, LAC^{FFLN}S, and UIE^{FFLN}S.

### IV. EXPLAINING THE CLAIMED INVENTION'S INVENTIVE CONCEPTS AND ITS CLAIMS

The claimed invention is made-up^{2),4)} from instantiations of •) the BED-in-C “KR-UIE” and “HI-UIE” as claimed by claims 1 and 15, and of •) further BED-in-C, e.g. the “IC-UIE”, as claimed by most dependent claims. The meanings of these (binary elementary disclosed) inventive concepts alias claim terms^{2),4)} [30,34] are defined to be storage cells capable of storing specific relations, which are for

KR-UIE: relations between items from the PTR-DS and IC-UIE instantiations,
IC-UIE: relations between IC-UIE and HI-UIE instantiations, all relations as explained with FIG. 1,
HI-UIE: relations between HI-UIE instantiations and items from the MEMEX.

Elaborating on the preceding Sections, additional details as to these 3 “claim terms” alias “inventive concepts”^{2),4)} of the claimed invention thus considering the claims also contributing in disclosing it/them, i.e. considering these claims as parts of this patent application's specification—are provided by the following list, not necessarily in the sequence as they are used in these claims. Also, functionalities immediately recognizable from the claims' wordings, remain without further comments.
• The complexity of the claimed invention's independent claim 1 resp. 16—for the sake of its comprehensibility its wording does not comprise the technical details known by the person of pertinent skill and creativity, posc—comes along with the advantage that the technical additional functionality comprised by the claimed invention's dependent claims is simple.
• The term/notion “technical teaching 0, TT.0” [6,7,11] may stand for the claimed invention disclosed in a patent's (application's) specification—the latter supposed to comprise also this claimed invention's claim—or for any other compilation of knowledge.
• The characteristics of a “model based” claimed invention alias TT.0 is explained in [25].
• For clarifications of the terms/notions “inventive concept, in-C”, “preemption”, . . . see^{2),4)} [5,8,25,34].
• Advanced IT knows that the input and commands provided by the user to the claimed invention just as the latter's output to the user must have, for being understandable by both, some before given—i.e. a priori defined or by the execution of the claimed invention—alphabet(vocabulary)/syntax/semantics/pragmatics. Parts or all of them may dynamically change during the claimed invention's execution, under the control by a user of the IES^{2),4)}.
• The term/notion “user” may stand for several persons using the IES.
• The term/notion “legal argument chain, LAC” stands for what is commonly understood by any posc. Its broad meaning is not limited in any other way. The index “Z” identifying a particular LAC.Z (alias instantiation Z of LAC) may belong to any—by the system implementation at issue initially given—set of “LAC identifiers”, which potentially is structured and/or expandable by this system's execution.
• There are basic UIE instantiations provided by an IES on top of a PTR-DS—the claimed invention of which is to be tested for satisfying SPL—which are available to a user all the time (unless locked by a user). By means of them a user may define and input for integration into and for execution by the IES a broad range of additional UIE instantiations for configuring the UIE between a user and the IES as desired by a user, for performing the above customization. Namely such as to facilitate for a user using the functionality provided by a PTR-DS based IES.
• Whether a UIE instantiation is to be integrated or executed is determined by the mode the claimed invention is in at input time—whereby this input of/to the UIE instantiation itself may set the mode or it may have been set prior to terminating this input, e.g. by another user, whereby conflicts may be resolved by the implementation of the claimed invention.
• An input or invocation may refer to only a step or move within a UIE instantiation.
• The HI-UIEs' information representations of a LAC to a user, in response to the latter's enquiry about some detail of the PTR-DS, or a FSTP test, or a LAC, or a UIE instantiation represents the kernel of the claimed invention. It serves the purpose the claimed invention has been invented for: To enable this LAC to react, in its response to being called, as if the response were provided by an all-knowing person.
• To this end, this response must be represented, if acoustically then as spoken by that person and if graphically then as being drawn by it. To this end, the claimed invention enables a user first to acoustically and/or graphically input fragments of the arguments it later intends to present in its personalized fashion, then to combine these fragments into what it considers to be a complete legal argument chain, and finally to invoke the automatic reproduction of this argument. Responding this way to a listener/viewer of this LAC—to a question it or somebody else had input to the claimed invention before as a query—then would appear to the listener/viewer as a personal and potentially multimedia announcement/information of a smart IMR system (IMR=interactive multimedia response). This “user personalization” of the behavior of the claimed invention's IMR subsystem would comprise that they may cooperate in jointly presenting a complex LAC by alternatively speaking or reacting on interposed questions by answering them immediately—whereby such prompt reactions may be configured to be interventions and/or accompanying illustrations, always under user control.
• Important thereby is that the claimed invention would execute much of this whole process automatically—i.e. of: α) recognizing what enquiry is being asked, β) identifying the set of possible answers, γ) compiling from the input fragments complete sequences of multimedia outputs controlled by HI-UIEs, which represent these answers, and finally δ) recognize when to output which of these replies. Evidently any one of these steps α)-β) may require some interactions with a user. These would be different when invoking a UIE instantiation in different modi, e.g. i) in explorative/calibrating mode, ii) in reply preparing mode, and iii) in reply mode, whereby this invocation may in between interact with the user iv) in some elaboration mode and thereafter v) in some consolidation mode—all these options not touching the kernel of the invention and not seeking patent protection.
• The claimed invention may provide “prototypes” of all such user interactions α)-γ) in i)-v), as well as macros for the stereotypically recurring parts of them, such as repeating some passage in other words or particularly slowly, or skipping momentarily boring details, or prompting a user to continue, or asking for confirmation the understanding of the just said, or . . . . But, LACs may also be presented by their default configurations coming with any FSTP-Test of a claimed invention. These prototype interactions are fine for inputting/defining/configuring specific UIE instantiations by a user for its personalization of the IES and/or its LACs for adapting them to the specificities of the actual PTR-DS under test—but normally these prototypes' functioning is far from what the USER ideally would like to use when actually testing a model based claimed invention for its satisfying SPL.
• Exceeding of what claim 1 describes for Action B), the IES implementation may comprise some exemplary LAC.Zs for test or demonstration purposes.
• While claim 1 knows only a static 1:1 relation between an AST.Z and its transformation into a LAC.Z, claim 2 enables a user to dynamically establish and modify n:m relations between AST.Ys and their transformations into a LAC.Ys.
• A determinant of the TSU is any syntactically correct part of the TSU.
• The content of a human interaction, i.e. its semantics, is currently transparent to the IES unless it is automatically derived by the IES from the AST at issue, occurring for very simple ASTs only.

### V. THE CLAIMED INVENTION SATISFIES THE US SPL

The claimed invention satisfies the 35 USC §§101, 102, 103, and 112—as it passes all 10 FSTP tests of FIG. 2 [5,6]. It namely passes⁸⁾

FSTP test 1: Technically, the claimed invention as of claims 1 and 16 and of their dependent claims is made-up by at least the two or more BED-cr-Cs disclosed by Sections III, each contributing to enabling to an increasing extent an IES user to customize its LAC^{FFLN}-UIE. Hence, disaggregating them is obsolete, i.e. performing the FSTP test 1 is trivial.

FSTP test 2: These three UIEs are lawfully disclosed by Sections III, IV, and the following claims; hence they are even the in-Cs of the claimed invention required by Mayo. Moreover: The FSTP-Test of the here claimed invention uses the same set of these three cr-Cs/in-Cs.

FSTP test 3: None of the claims comprises a “means-plus-function” wording.

FSTP test 4: The disclosures of the three UIEs and hence of the claimed invention—in Sections III, IV, and in the following claims—are enabling.

FSTP test 5: The three UIEs are evidently independent.

FSTP test 6: The three UIEs are posc-nonequivalent, as there is no prior art for them.

FSTP test 7: The claimed invention is evidently novel and nonobvious⁹⁾.

FSTP test 8: The claimed invention passes the NAIO test, as the problem P it is invented to solve is identified in Section I, and if one of its 3 in-Cs is left away it does not solve it—i.e., the claimed invention is not an abstract idea only.

FSTP test 9: The claimed invention is evidently not a natural phenomenon only; the contrary is true: none of its 3 in-Cs represents a natural phenomenon.

FSTP test 10: The claimed invention is not idempotent, because of the FSTP tests 7 and 9.

Hence, as mentioned/explained above, the here claimed invention satisfies the US SPL.

Finally, it is worthwhile noticing that [25] has shown that this is guaranteed to be true if and only if the claimed invention passes all 10 FSTP tests which in total even comprise 16 tests (see FIG. 1 in [25])—of which the classical claim construction only performs 6 ones, as shown by FIG. 1 in [25]. To put it into the context at issue here, the classical claim construction is an abstract idea only of a claim construction, as it is an invention which does not solve the problem set out to be solved by it, namely to determine whether a claimed invention satisfies the US SPL or not—though one might argue that the classical claim construction never has been set out to achieve this solution.

### BRIEF DESCRIPTION OF THE DRAWINGS

FIG. 1 shows a LAC.Z and its UIE.Ys comprising such sequential UIE.Y parts semi-automatically generated/customized, by generating/customizing for them their HI-UIE.Ys, KR-UIE.Ys, and IC-UIE.Ys.

FIGS. 2a-2b shows an illustration of the 10 FSTP tests.

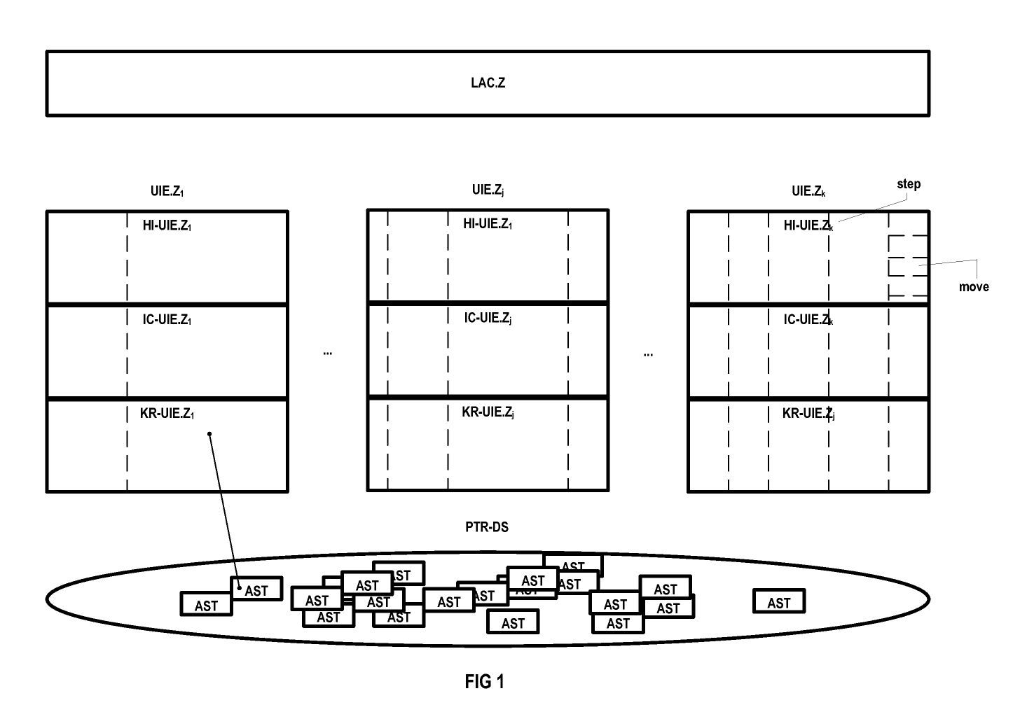

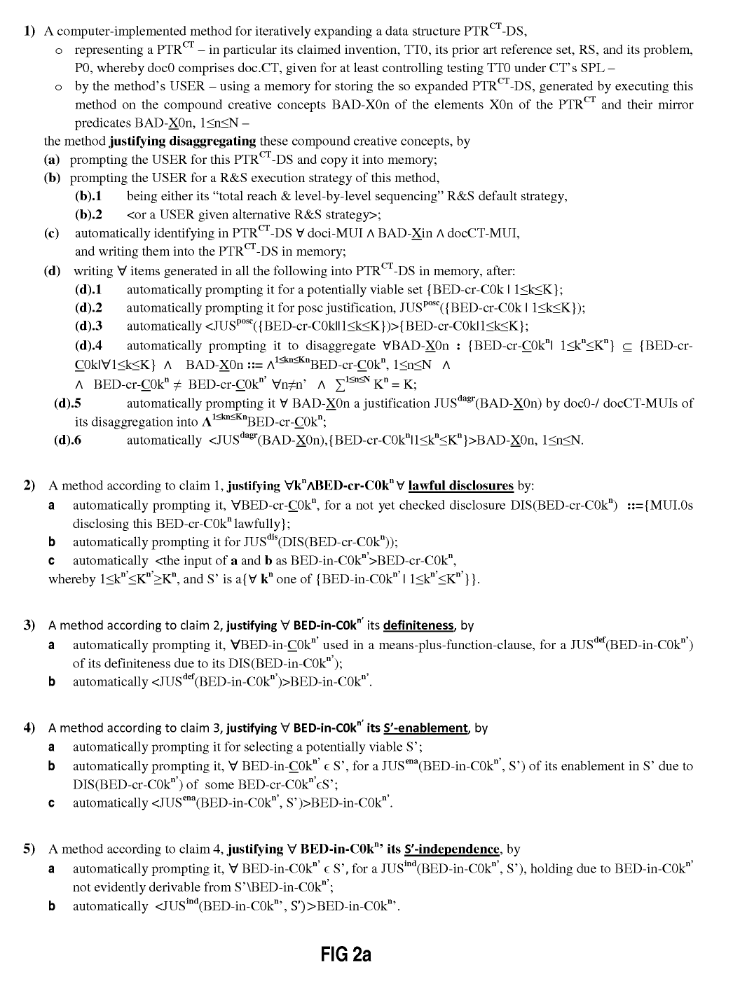

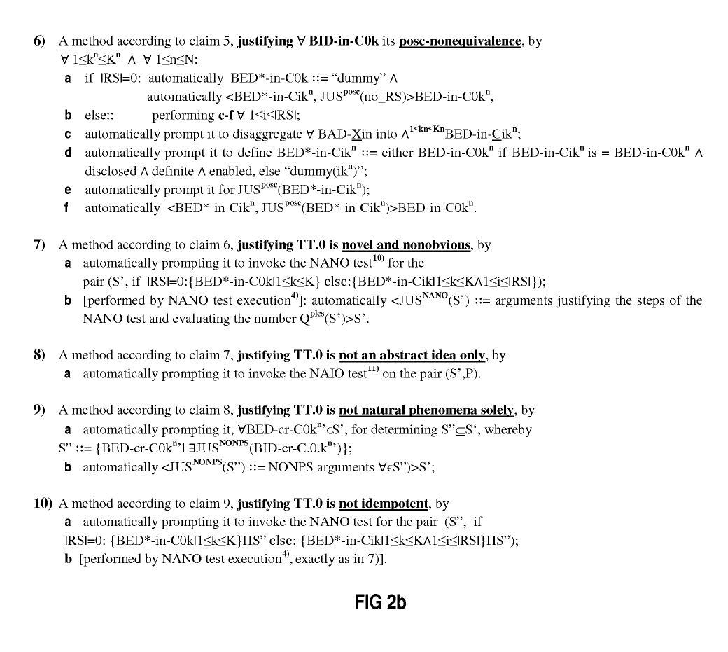

### REFERENCES

[1] S. Schindler, “US Highest Courts' Patent Precedents in Mayo/Myriad/CLS/Ultramercial/LBC: ‘Inventive Concepts’ Accepted—‘Abstract Idea’ Next? Emerging Technology Patents: Intricacies Overcome.” 2013.
[2] “advanced IT” is a generic term for IT areas, e.g. AI, Semantics, KR, DL, NL, . . .
[3] R. Brachman, H. Levesque, “Knowledge Representation and Reasoning”, MK, 2004.
[4] F. Baader, D. Calvanese, D. McGuinness, D. Nardi, P. Patel-Schneider, “The Descrip. Logic Handbook”, CUP, 2010.
[5] S. Schindler, “Mathematically Modelling SPL Top-Down vs. Bottom-Up”, Yokohama, JURISIN-2013.
[6] S. Schindler, “The FSTP Expert System”, 2012, Patent Application.
[7] S. Schindler, “The Innovation Expert System, IES, and its PTR-DS”, 2013, Patent Application
[8] J. Schulze, “Tech. Rep. #1.V1 on the '882 PTR and UI of the IES prototype”.
[9] S. Schindler, “Patent Business—Before Shake-Up”, Marketing Paper, 2013.
[10] S. Schindler, “Amicus Brief in LBC v. Philips”, to CAFC, 2013.
[11] S. Schindler, “Inventive Concepts Enabled Semi-Auto. Tests”, 2013, Patent Application
[12] C. Correa, “Research Handbook on Protec. of IP under WTO”, EEP, 2010.
[13] N. Klunker, “Harmonisierungsbestrebungen im mat. Patentrecht”, MPI, 2010.
[14] USPTO, “2111 Claim Interpret; Broadest Reasonable Interpretation [R-9]”.
[15] S. Schindler, “KR Support for SPL Precedents”, Lisbon, eKNOW-2014.
[16] J. Daily, S. Kieff, “Anything Under the Sun Made by Humans: Pat. Law Doct. as Endo. Inst. for Comm. Inno.”, 2013.
[17] Enbanq Hearing in LBC, CAFC, Dec. 9, 2013.
[18] S. Schindler, “Amicus Brief in Alice v. CLS.”, to Supreme Court, 2013.
[19] S. Schindler, “Amicus Brief in WildTangent v. Ultramercial”, to Supreme Court, 2013.
[20] USPTO, “IP and the US Economy: INDUSTRY IN FOCUS”, 2012.
[21] K. O'Malley, “Keynote at IPO-2013”.
[22] S. Schindler, “The View of an Inventor at the Grace Period”, Kiew, 2013.
[23] S. Schindler, “The IES and its In-C Enabled SPL Tests”, Munich, 2013.
[24] S. Schindler, “Two Fundamental Theorems of ‘Mathematical Innovation Science’”, Hong Kong, ECM-2013.
[25] S. Schindler, A. Paschke, S. Ramakrishna, “Formal Legal Reasoning that an Invention Sat. SPL”, Bologna, JURIX-2013.
[26] S. Schindler, “Semi-automatic Custom. of LACs that a Claimed Invention Satisfies. SPL, . . . in-Cs”, 2014, Patent Appl.
[27] T. Bench-Capon, F. Coenen: “Isomorphism and Legal Knowledge Based Systems”, AI & Law, 1992.
[28] N. Fuchs, R. Schwitter. “Attempt to Control English”, 1996.
[29] A. Paschke: “Rules and Logic Programming for the Web”. 7. ISS, Galway, 2011.
[30] K. Ashley, V. Walker, “From Information retrieval to Argument Retrieval for Legal Cases: . . . ”, Bologna, JURIX-2013.
[31] Hearing in Oracle vs. Google, “As to the Copyrightability of the Java Platform”, CAFC, Jun. 12, 2013.
[32] S. Schindler, “A KR Based Innovation Expert System (IES) for US SPL Precedents”, Phuket, ICIM-2014.
[33] Schindler, “Status Report About the FSTP Prototype”, Hyderabat, GIPC-2014.
[34] S. Schindler, “Semi-Automatic Generation/Custom. of All Confirmative LACs”, subm. to Paris, UPMC/DSS2.0-2014.
[35] S. Schindler, “Substantive Copyright Law (SCL) and SPL—SCL Tests Are True SPL Subtests”, in preparation.
[36] S. Schindler, “Inventive Concepts are not Just Inventive—They are Multi-Mongrels”, in preparation.
[A] “KSR v. Teleflex”—Supreme Court, 2007.
[B] “Bilski v. Kappos”—Supreme Court, 2010.
[C] “Mayo v. Prometh.”—Supreme Court, 2012.
[D] “Myriad v. AMP”—Supreme Court, 2013.
[E] “Bowman v. Monsanto Co.”—Supreme Court, 2011.
[F] “CLS Bank. v. Alice”—CAFC, 2013.
[G] “Ultramercial v. WildTangent”—CAFC, 2013.
[H] “LBC v. Phillips”—CAFC, 2013.
[I] “Accenture v. Guidewire”—CAFC, 2013.
[J] “Funk Brothers v. Kalo”—Supreme Court, 1948.
[K] “Diamond v. Chakrabarty”—Supreme Court, 1980.
[L] “Markman v. Westview”—CAFC, Supreme Court, 1995/96.
[M] “Phillips v. AWH Corp.”—CAFC, 2005.

### FOOT-/ENDNOTES

¹While today differences still exists between the “Substantive Patent Laws, SPLs” of the US and other regions/nations, e.g. the EU with its EPC-SPL, these should disappear soon, as internationally harmonizing SPLs is politically less controversial and economically highly beneficial for all parties as being “Highest Courts” proof. Many similar processes occurred in the past, e.g. with the various national accounting procedures of public companies, today harmonized by the IFRS (International Financial Reporting Standard), accepted worldwide.

²The Mayo decision uses the term “inventive concept” only three times and often omits or replaces it by other terms, e.g. in “. . . do the patent claims add enough <inventive concepts> to . . . .”, or “. . . unless the process has additional features <alias: inventive concepts> that . . . ”, or “What else <inventive concept>is there . . . ”, or “Those steps <alias: inventive concepts> included . . . ”. The synonyms in Mayo for the term “inventive concept” tell: An inventive concept may show-up, in a claimed invention's specification, by a synonym or only implicitly.

A term together with its meaning is a “notion”. A notion hence defines its term's meaning. In Mayo a notion is called an “inventive concept”⁵⁾, if its meaning has the pragmatics to serve for defining the claimed invention's “§101 usefulness”, this pragmatics being disclosed by the claimed invention's specification (unless known a priori by the person of ordinary skill and creativity). A notion, and hence also the notion “inventive concept” may be represented by different terms (=synonyms, as the preceding paragraph exemplifies).

In the above Phillips opening statement, the “claim term” is a “claim's term” representing an inventive concept⁴⁾. Other “claim's terms”, not having that pragmatics, are no inventive concepts. The Phillips decision deals only with claim terms⁴⁾ alias inventive concepts. For convenience it mostly leaves away the leading “claim”. But not in its opening statement, i.e. its “baseline” statement, elaborate on above in α) and below in i).

Just for information: A term in a claim may also represent two different meanings, in particular one meaning with and the other meaning without inventive concept pragmatics, it then can be seen as a claim term or as a plain claim's term—the latter representing a legally inadmissible as “contra Phillips/Mayo” meaning.

The BRI guideline ignores this distinction and thus is often very confusing, for not to say: right away misleading. It thus invites the misunderstanding that a claim's term always is a claim term, which unreasonably broadens the meaning of the resp. claim³⁾. Mayo bars this misunderstanding by introducing the term “inventive concept” as synonym to “claim term”. For “inventive concept” being legal items—not factual ones—see [5,7,11].

³⁻This real life example for the (mis)use of the BRI guideline is provided by a §103 attack on the author's '902 U.S. Pat. No. 7,145,902 and its claim 68, which confirmed to be based on the BRI guideline). It then also shows that and how the specification of a model based claimed invention is always facilitated by its implicit model.

The volitional broadening of the meanings of the '902 claim terms is achieved as follows. While
• claim 68 starts with limiting this claim's scope to i) a telephone call, and then therein focuses on ii) a very specific and novel '902 control signal for iii) changing-over, whereby the iv) packet-switching network usually provides—the '902 priority date is 1995—a bandwidth of only approx. 9.6 kbit/s (as the '902 specification states up-front), the
• §103 attack determines these 4 claim 68 terms' meanings independently of its claimed invention⁴⁾. It
   a. determines the meanings of the terms “packet-/line-switching networks” a “telephone call” totally ignoring that the claimed invention must get along with approx. 9.6 kbit/s for the telephone call's communications connection, the resp. compression to be performed within the '902 switch. Hence, its general discussion of these two terms has nothing to do with the claimed invention of claim 68.
   b. The attack lumps the two terms “control signal” and “changing-over” together and argues their meanings are the commonly known broad ones—although the '902 specification clearly describes for both these terms their very specific and novel meanings necessary for making the claimed invention work.

Two final comments on this untenable attack: 1.) Today the claimed invention of claim 68 is often called VoIP telephony. 2.) Based on the '902 specification the USPTO recently granted 3 more patents to the author.

The '902 patent also is a nice example of its claimed invention being model based—a common feature of practically all emerging technology inventions, see Section I—and how therein their models are used for precisely describing the resp. claimed invention.

In the '902 case, as always in telecommunications, the underlying model is the ISO/OSI Reference Model and internationally standardized (while most specifications of model based claimed inventions use their own or some group's agreed on and hence non-standardized models). As is typical with reference systems alias paradigms alias models, they prescribe only commonly known features of the basic structures and functioning of the objects they support modeling, i.e. never describe all their technical details. Here the subject matter object modeled is a “communications connection”. Some commonly known features of a communications connection are that it is an end-system-to-end-system connection alias association on this model's layer 7, whereby any association exists as soon as its associated entities are known. An existing communications connection/association is routed over many entities, may be routed over different networks, and its protocol data units, PDUs (here IP-packets) may be monitored by such entities—as used by the '902 specification, enabled by the model underlying the '902 claimed invention.

And similarly is a DNA invention supported by a model representing some common DNA knowledge. ⁴A patent specification may disclose several inventions. A first consequence is that a claim seeking patent protection for one of them must identify which one of them, which then is called this claim's “claimed invention”.

While this was recognized long a time ago, it is only the Phillips decision that explicitly addressed the second consequence as explained in ²⁾, namely to assure in a claim interpretation—when determining the meaning of a claim explicitly used by a term in this claim or implicitly by its notion's indispensability for the functioning of the claimed invention, in both cases as enablingly/lawfully disclosed by this specification ex- and/or implicitly [25], all 4 combinations covered (ex- and/or implicitly) by the elaborations of Phillips and now even enforced by Mayo²⁾—the meanings of the terms/notions this claim ex- and/or implicitly uses are determined such as those needed by the disclosed claimed invention. Phillips hence calls such terms/notions of this claim—analogously to its “clamed invention”—as “claim terms”²⁾, in particular in its “opening statement” (quoted above) and several more places, though also often skipping the leading “claim”, probably by convenience/evidence. Markman did not yet address this intricacy in claim construction, i.e. nowhere talks of “claim terms”, evidently assuming the simple case that a patent specification comprises no opportunity for this mismatch or that the reader is problem aware enough. That the USPTO's BRI guideline does not own this problem awareness is shown by ³⁾—where it does not bar determining the claimed invention's key meanings totally independent of the claimed invention. ⁵The mathematical definition of the notion “inventive concept”, as provided earlier [5-11], is a dramatic simplification of the “technical” much more powerful notion of “concept” in DL or KR [2-4], as it is here customized to the current needs of modeling FFLN/SPL precedents. Inventive concepts need to model the properties of only constants (being the elements of the claimed invention), nothing else, while in DL or KR concepts serve for modeling how to recursively build compound concepts out of simpler concepts. By contrast, modeling the Highest Courts' SPL precedents needs only a simple disaggregation of compound inventive concepts into elementary ones [5-11]. But legally this notion of “inventive concept” is very powerful, as shown by [25,36].⁶The “inventivity” of a claimed invention, i.e. embodied by it, is represented by all its invented—hence by this inventivity created—properties of all its elements, thus making-up its total usefulness⁷⁾.⁷The “usefulness” of a claimed invention, i.e. embodied by it, is just as its inventivity, represented by this claimed invention's total set of properties (in patent language: “limitations”). Thus, from the definition of its inventive concepts (namely: to make-up this claimed invention) follows that any one of them contributes—by its contribution to the total set of properties/limitations of the claimed invention—equally to the claimed invention's usefulness, as required by §101 and its interpretation by the Supreme Court's Mayo decision.

The Mayo decision invokes, for its refined claim construction for a claimed invention, this additional “contribution to its usefulness” minded view at its claimed invention's inventive concepts—which nothing changes with their hitherto only “contribution to its total limitations” minded meanings, remaining true for the classical claim construction for it. It is this additional “contribution to its usefulness” minded pragmatics of the inventive concepts, by which Mayo achieves the conciseness and coherence of its refined claim construction. ⁸Due to the novelty of this part of the specification, many details—also evident ones—are briefly explained in this Section or its below footnotes. In a future patent application trivial such explanations would be superfluous. If this future patent application were supported by its PTR-DS as disclosed by [11]—or even by a SES as disclosed by this patent application—then all such explanations, also the trivial ones, would be presented to a user on its request in realtime, as embodied by the PTR-DS's as AST or FSTP test respectively by the claimed invention, i.e. its SES, as this AST's peer LARC.⁹That performing the NANO test on the here claimed invention determines its creative height to be 3 over pertinent ordinary skill and creativity (“posc”)—given that there is no prior art. And in [5,6] is shown that already a claimed invention's creative height
• 1 warrants its novelty as by posc and by a prior art document one of it in-Cs is not anticipatable, and its
• 2—anyway 3—warrants its nonobviousness as by posc and by a combinations of prior art documents 2 resp. 3 of its in-Cs are not anticipatable. ¹⁰For the NANO test see [5]; its detailed explanation may be found in [6].¹¹For the NAIO test also see [5]. As it embodies intricacies, its steps are here repeated:
   a automatically prompts the USER to state the usefulness of the claimed invention—denoted as “the problem, P” (to be) solved by it^{2),3)} over S′;
   b automatically prompts the USER to identify DIS^{NAIO}(S′, P)::={doc.0-MUIs describing/disclosing P (to be) solved by it over S′};
   c automatically <DIS^{NAIO}(S′,P)>S′;
   d automatically prompts the USER, ∀BED-cr-C0kⁿ′εS′, through any doc.0-MUI, for justifying by JUS^{NAIO}(S′,P,BED-cr-C0kⁿ′) that the latter is indispensable in the claimed invention for enabling it to solve P; (as explained in [5])
   e automatically <{JUS^{NAIO}(S′,P,BED-cr-C0kⁿ′)|∀BED-cr-C0kⁿ′εS′}>DIS^{NAIO}(S′,P).

What is claimed is:

1. A computer-implemented method of generating, customizing and providing “Legal Argument Chains, LAC.Z”, Z=1,2,3, . . . , by a “Innovation Expert System, IES”,
this IES comprising at least one of a processor, a memory for storing the method's executable code for the processor, an I/O device in particular for human interaction with an IES user, and
•) a “User Interface Entity, UIE”, composed of UIE.Y, Y=1,2,3, . . . ,
•) at least one UIE.Y per LAC.Z,
•) a “Memory of Method Execution, MEMEX”, comprising a set of storage cells, “KR-UIE.Y” and “HI-UIE.Y”, and a “Global Bibliography, GloBi”, accessible to the processor, and
•) IES being capable of running in a config-mode or a realtime-mode, and
the IES further comprising—since before starting the execution of this method or input to the IES during its execution via an I/O device of the IES—the “Test Set-UP, TSU” comprising the test determinants:
•) a given “First Order Logic Finite Legal Norm, FFLN” in some given notation,
•) a given “Pair of a <Technical Teaching^{FFLN}, Reference Set^{FFLN}>, PTR^{FFLN}”
—and leaving away the index “FFLN” here and for all terms in the rest of the claims, e.g. a “Pair of a <Technical Teaching, Reference Set>, PTR”—and
•) a given “PTR Data Structure, PTR-DS”
with “Some Innovation in FFLN, SI” is the “Technical Teaching in FFLN, TT.0” of the PTR and an FSTP-Test such that SI satisfies FFLN if and only if PTR passes this FSTP-Test and PTR-DS is the evidence that PTR satisfies FFLN by this FSTP-Test, and
•) a given “Arguable Subtest of this FSTP-Test of PTR, AST”,
with AST stored by some KR-UIE.Y,
for use by an IES user or the IES when executing the method, this execution comprising repeated invocations of the executions of the Action A) in a config-mode or B) in a realtime-mode of the IES:
A) the IES automatically prompts the user—to enable a UIE.Y to present in B) a LAC.Z in realtime mode—to invoke the IES to
i. automatically identify a KR-UIE.Y storing an AST to be transformed into a LAC.Z, and
ii. automatically identify an unused HI-UIE.Y, into which to input by a user—as part of Action A)—what the content and the representations shall be of LAC.Z, then supposed to represent the transformation of the AST on an I/O device of the IES, and to
iii. automatically input “LAC.Z::=<KR-UIE.Y, HI-UIE.Y> into the GloBi.
B) i. the IES automatically prompts the user to identify a LAC.Z in the GloBi, and
ii. the IES automatically presents the LAC.Z as defined in A) iii.

2. A computer-implemented method according to claim 1), with MEMEX containing also a set of storage cells, “IC-UIE.Y”, which comprises after A) ii. a step A) iii.:
“iii. an unused IC-UIE.Y and inputting into it what control commands as to presenting on an I/O device of the IES the content and the representations stored in ii. shall be available to the IES or a IES user, anytime while this LAC.Z is invoked in realtime-mode”, making the previous step A) iii. become step A) iv.,
“iv. automatically input “LAC.Z::=<KR-UIE.Y, HI-UIE.Y, IC-UIE.Y>into the GloBi”.

3. A computer-implemented method according to claim 1), whereby the action B) is expanded by “, whereby when and while executing this presentation, the IES or an IES user may invoke anytime a control command as of A) iii.”

4. A computer-implemented method according to claim 1), whereby
•) a LAC.Z may be sub-structured into the components “Legal Argument Chain Steps, LACS.Z.S^{Z.S}”, 1≦Z.S≦ZS, which each may comprise “Legal Argument Chain Moves, LACM.Z.M^{Z.S.M}”, 1≦Z.S.M≦ZSM (ZS≧0 and ZSM≧0 given by a method's implementation),
•) any UIE.Z.Y, Y=1,2,3, . . . , peer to a LAC.Z is sub-structured exactly the same way into the components UIES.Z.Y.S^{Z.S}, UIEM.Z.Y.M^{Z.S.M}, and
•) this sub-structure may be determined by the IES or an IES user and
•) any operation defined in A) and B) applies to all components of any LAC.Z and its UIE.Z.Ys.

5. A computer-implemented method according to claim 1), whereby at least one AST may be
•) completely input by the IES user, or
•) automatically derived by the IES from a PTR-DS part identified by a IES user, or
•) automatically derived by the IES from a PTR-DS by determining all the ASTs it comprises.

6. A computer-implemented method according to claim 1), whereby the PTR-DS or at least one of its determinants may be
•) completely input by the IES user, or
•) partially input by the IES user and automatically complemented by the IES, or
•) automatically suggested by the IES.

7. A computer-implemented method according to one of the claim 2), whereby the functionality of an HI-UIE.Y or IC-UIE.Y or KR-UIE.Y may be determined:
•) completely by input provided by the IES user, or
•) partially input by the IES user and automatically complemented by the IES, or
•) automatically suggested by the IES.

8. A computer-implemented method according to one of the claim 2), whereby the functionality of an HI-UIE.Y or IC-UIE.Y or KR-UIE.Y may be based on relations between parts of different instantiations of HI-UIE.Ys or IC-UIE.Ys or KR-UIE.Ys.

9. A computer-implemented method according to claim 1), whereby FFLN is a “Substantive Patent Law, SPL” or a “Substantive Copyright Law, SCL”.

10. A computer-implemented method according to claim 1), whereby FFLN is a conjunction of FFLNs.

11. A computer-implemented method according to claim 1), whereby its FFLN is augmented by the user preserving its finite FOL property.

12. A computer-implemented method according to claim 1), whereby the representation of the user input provided to the IES may be identified by the user by either selecting such a representation from a given set of such representations or by describing it in a given notation.

13. A computer-implemented method according to claim 1), whereby the output representation to be used by the IES may be identified by the user by either selecting such a representation from a given set of such representations or by describing it in a given notation.

14. A computer-implemented method according to claim 1), whereby the input into a HI-UIE.Y is automatically generated by the IES what the content and the representations shall be of the LAC.Z, representing part of the transformation of a given AST on an I/O device of the IES—whereby said representation is given by the IES implementation or to the IES by a user in some given notation.

15. A computer-implemented method according to claim 11), whereby its Action A) is begun by
“the IES automatically prompts the user to enable UIE.Ys to present in B) for any AST in PTR-DS its peer automatically generated LAC.Z in realtime mode to invoke
o. the IES to repeatedly automatically identify in PTR-DS another non-translated AST and execute with it i.-iii.:”

16. A computer-implemented system of generating, customizing and providing “Legal Argument Chains, LAC.Z”, Z=1,2,3, . . . , by a “Innovation Expert System, IES”,
this IES comprising at least one of a processor, a memory for storing the method's executable code for the processor, an I/O device in particular for human interaction with an IES user, and
•) a “User Interface Entity, UIE”, composed of UIE.Y, Y=1,2,3, . . . ,
•) at least one UIE.Y per LAC.Z,
•) a “Memory of Method Execution, MEMEX”, comprising a set of storage cells called “KR-UIE.Y”, “HI-UIE.Y”, and “IC-UIE.Y” and a “Global Bibliography, GB”, accessible to the processor, and
•) IES being capable of running in a config-mode or a realtime-mode, and
the IES further comprising—since before starting the execution of this method or input to the IES during its execution via an I/O device of the IES—the “Test Set-UP, TSU” comprising the test determinants:
•) a given “First Order Logic Finite Legal Norm, FOLLN alias FFLN” in some given notation,
•) a given “Pair of a <Technical Teaching^{FFLN}, Reference Set^{FFLN}>, PTR^{FFLN}”
—and leaving away the index “FFLN” here and for all terms in the rest of the claims, e.g. a “Pair of a <Technical Teaching, Reference Set>, PTR”—and
•) a given “PTR Data Structure, PTR-DS”
with “Some Innovation in FFLN, SI” is the “Technical Teaching in FFLN, TT.0” of the PTR and an FSTP-Test such that SI satisfies FFLN if and only if PTR passes this FSTP-Test and PTR-DS is the evidence that PTR satisfies FFLN by this FSTP-Test, and
•) a given “Arguable Subtest of this FSTP-Test of PTR, AST”,
with AST stored by some KR-UIE.Y,
for use by an IES user or the IES when executing the method, this execution comprising repeated invocations of the executions of the Action A) in a config-mode or B) in a realtime-mode of the IES:
A) automatically prompting the user by the IES to enable a UIE.Y to present a LAC.Z in realtime mode, namely by identifying
i. a KR-UIE.Y storing an AST to be transformed into a LAC.Z,
ii. a HI-UIE.Y and inputting into it what the content and the representations shall be of the LAC.Z, representing the transformation of the AST on an I/O device of the IES,
iii. input into GB “LAC.Z::=<KR-UIE.Y, HI-UIE.Y>.
B) automatically prompting the user by the IES to identify a LAC.Z comprised by GB and then present LAC.Z as defined in A) iii.

17. A computer-implemented system according to claim 16), comprising after ii. a step iii.:
“iii. a IC-UIE.Y and inputting into it what control commands as to presenting on an I/O device of the IES the content and the representations stored in ii. shall be available to the IES or a IES user, anytime while this LAC.Z is invoked in realtime-mode”,
making the previous step iii. become step iv.,
“iv. input into GloBi “LAC.Z::=<KR-UIE.Y, HI-UIE.Y, CI-UIE.Y>.

18. A computer-implemented system according to claim 16), whereby the action B) is expanded by “, whereby when and while executing this presentation, the IES or an IES user may invoke anytime a control command as of A) iii.”

19. A computer-implemented system according to claim 16), whereby
•) a LAC.Z may be sub-structured into the components “Legal Argument Chain Steps, LACS.Z.S^{Z.S}”, 1≦Z.S≦ZS, which each may comprise “Legal Argument Chain Moves, LACM.Z.M^{Z.S.M}”, 1≦Z.S.M≦ZSM (ZS≧0 and ZSM≧0 given by a method's implementation),
•) any UIE.Z.Y, Y=1,2,3, . . . , peer to a LAC.Z is sub-structured exactly the same way into the components UIES.Z.Y.S^{Z.S}, UIEM.Z.Y.M^{Z.S.M}, and
•) this sub-structure may be determined by the IES or an IES user and
•) any operation defined in A) and B) applies to all components of any LAC.Z and its UIE.Z.Ys.

20. A computer-implemented system according to claim 16), whereby at least one AST may be
•) completely input by the IES user, or
•) automatically derived by the IES from a PTR-DS part identified by a IES user, or
•) automatically derived by the IES from a PTR-DS by determining all the ASTs it comprises.

21. A computer-implemented system according to claim 16), whereby the PTR-DS or at least one of its determinants may be
•) completely input by the IES user, or
•) partially input by the IES user and automatically complemented by the IES, or
•) automatically suggested by the IES.

22. A computer-implemented system according to one of the claim 17), whereby the functionality of an HI-UIE.Y or IC-UIE.Y or KR-UIE.Y may be determined:
•) completely by input provided by the IES user, or
•) partially input by the IES user and automatically complemented by the IES, or
•) automatically suggested by the IES.

23. A computer-implemented system according to one of the claim 17), whereby the functionality of an HI-UIE.Y or IC-UIE.Y or KR-UIE.Y may be based on relations between parts of different instantiations of HI-UIE.Ys or IC-UIE.Ys or KR-UIE.Ys.

24. A computer-implemented system according to claim 16), whereby FFLN is a “Substantive Patent Law, SPL” or a “Substantive Copyright Law, SCL”.

25. A computer-implemented system according to claim 16), whereby FFLN is a conjunction of FFLNs.

26. A computer-implemented system according to claim 16), whereby its FFLN is augmented by the user preserving its finite FOL property.

27. A computer-implemented system according to claim 16), whereby the representation of the user input provided to the IES may be identified by the user by either selecting such a representation from a given set of such representations or by describing it in a given notation.

28. A computer-implemented system according to claim 16), whereby the output representation to be used by the IES may be identified by the user by either selecting such a representation from a given set of such representations or by describing it in a given notation.

29. A computer-implemented system according to claim 16), whereby the input into a HI-UIE.Y is automatically generated by the IES—what the content and the representations shall be of the LAC.Z, representing part of the transformation of a given AST on an I/O device of the IES—whereby said representation is given by the IES implementation or to the IES by a user in some given notation.

30. A computer-implemented system according to claim 16), whereby its Action A) is begun by
“the IES automatically prompts the user to enable UIE.Ys to present in B) for any AST in PTR-DS its peer automatically generated LAC.Z in realtime mode to invoke
o. the IES to repeatedly automatically identify in PTR-DS another non-translated AST and execute with it i.-iii.:”
